(19) United States
(12) Patent Application Publication
(10) Pub. No.: US 2016/0285409 A1
(43) Pub. Date: Sep. 29, 2016

(54) SYSTEM AND METHOD FOR CONTROLLING A DUAL-AXIS SOLAR ARRAY TRACKER BASED ON SOLAR ARRAY OUTPUT SIGNALS

(71) Applicant: The Boeing Company, Chicago, IL (US)

(72) Inventor: D. Anthony Galasso, Trabuco Canyon, CA (US)

(21) Appl. No.: 14/665,096

(22) Filed: Mar. 23, 2015

(51) Int. Cl. H02S 20/32; G01R 31/40; H02S 40/32

(52) U.S. Cl. CPC H02S 20/32; H02S 50/00; H02S 40/32

(57) ABSTRACT

A solar array tracking system includes a solar array module having at least three separate cells mounted on a platform coupled to a drive mechanism. Each separate cells provides an electrical output in direct current form. Micro-inverters are provided for each of the separate cells. Each micro-inverter receives the electrical signal output from the associated cell and convert the electrical signal to alternating current form and provided such signal on an output thereof. Sensors, one for each micro-inverter, provide an output signal proportional to a magnitude of the electrical power or energy provided by the associated micro-inverter. A controller is coupled to receive the output signals from each of the sensors. The controller is configured to generate control signals for the drive mechanism that move the platform and solar array module such that the electrical output signals from each of the separate cells in the solar array module are optimized.

### FIELD

This disclosure relates generally to a system and method for controlling a dual-axis solar array tracker based on the actual output of each portion of a segmented solar array.

### BACKGROUND

Solar arrays may include any number of photovoltaic cells that collect and convert sunlight into electricity. Depending on the application for which any solar array is designed, a solar array may be fixed in place or may track the movement of the sun. As solar technology improves, the size of photovoltaic cells will continue to decrease. In addition, a concentrated photovoltaic (“CPV”) cell typically includes a photovoltaic element that produces electric power from incident sunlight and a focusing element that concentrates the sunlight falling over a protracted area onto the cell. To optimize efficiency in electrical generation of such CPV cell, the focusing element should be pointed as accurately as possible toward the sun, within better than a degree, and should move with the sun in a sun tracking manner. CPV cells are generally grouped in arrays such that the CPV cells are pointed toward the sun when the array is pointed toward the sun. As a result, it is desirable to closely track the movement of the sun both with a normal solar array and with an array based on CPV cells in an effort to maximize the focus of the sunlight on the corresponding photovoltaic cells, and therefore maximize the efficiency of the solar array.

Many conventional solar power generators utilize a two-axis solar tracker mechanism (“solar tracker”) to track the sun. The first axis is a horizontal axis, or elevation axis, around which the solar tracker rotates the solar array up and down in elevation. The second axis is a vertical axis, or azimuth axis, around which the solar tracker rotates the solar array around in a circle parallel to the ground. Using this two-axis tracking system, the solar tracker attempts to track the sun as it moves across the sky as accurately as possible in view of the technique used to identify the sun location.

A typical solar tracking system may include, for example, separate sun sensors, such as photodiodes, pixel cameras or the like, that are mounted in view of the sun and are exposed to the environment. Such sun sensors are arranged to indicate the sun position relative to the array. However, such sun sensors generally have pointing vectors that are skewed from that of the array, thereby requiring calibration in two-dimensions—a non-trivial operation. Once calibrated, the array is moved to track the sun by motors in a closed loop manner with the sun sensor outputs. However, the sun sensors cannot be located coincident with the array, and therefore this system optimizes the sun signal at the sun sensor itself and not at the array. Therefore, the use of sun sensors introduces the need for significant calibration prior to installation, on-going maintenance to keep the sun sensor aligned with its original pointing vector and error due, for example, to the difference in position between the sun sensors and the array.

Another conventional approach to solar tracking uses the calculable sun position as a function of array latitude/longitude and time. Once the sun zenith and azimuth position is known, angle encoders having sub-degree resolution provide array orientation feedback to point the array toward the sun. However, angle encoders are expensive and must be protected from the environment. Furthermore, a calibration step is required to determine the array pointing vector with respect to the angle encoder outputs. Finally, this approach introduces relatively significant errors based positional uncertainty, etc. Other errors may be introduced in conventional systems, including errors caused by jitter in timing signals and sag error caused by the movement of structure support during tracking

Accordingly, there is a need for solar array tracker system which overcomes the aforementioned problems and more accurately tracks the sun with respect to the solar array itself.

### SUMMARY

In one aspect, a solar array tracking system is described which includes a solar array having at least three separate cells. Each of the separate cells provides an electrical output in direct current form. The solar array is mounted on a platform coupled to a drive mechanism that is configured to move the platform and solar array in response to received control signals. The system also includes a plurality of inverters, one invertor for each of the plurality of separate cells in the solar array. Each of the plurality of inverters has an input coupled to receive the electrical output from a respective one of the plurality of separate cells in the solar array. Each of the inverters is configured to convert the electrical output signal of the associated one of the plurality of separate cells in the solar array to alternating current form provided on an output thereof. The system also includes a plurality of sensors, one sensor for each of the plurality of inverters. Each sensor is configured to provide an output signal proportional to a magnitude of the electrical power or energy provided by the associated inverter. Finally, the system includes a controller coupled to receive the output signals from each of the plurality of sensors and configured to generate the control signals for the drive mechanism that move the platform and solar array such that the electrical output signals from each of the separate cells in the solar array are optimized.

In a further embodiment, each of the plurality of inverters may be a micro-inverter. Likewise, each of the plurality of sensors may be a Hall effect sensor. In one alternative embodiment, each of the plurality of sensors may be within the associated inverter. In another alternative embodiment, each of the plurality of sensors may be configured to sense the magnitude of the electrical power or energy provided by the associated inverter at an output of the associated inverter. In a still further alternative embodiment, each of the plurality of sensors may be configured to sense the magnitude of the electrical power or energy provided by the associated inverter at an input of the associated inverter. In another further embodiment, the solar array may have four separate cells. In still another further embodiment, the solar array may have a multiple of four separate cells.

In another aspect, a solar array tracking system is described which includes a solar array having at least three separate cells. Each of the separate cells provides an electrical output in direct current form. The solar array is mounted on a platform coupled to a drive mechanism. The drive mechanism is configured to move the platform and solar array in response to received control signals. The system also includes a plurality of inverters, one invertor for each of the plurality of separate cells in the solar array. Each of the plurality of inverters has an input coupled to receive the electrical output from a respective one of the plurality of separate cells in the solar array. Each of the inverters is configured to convert the electrical output signal of the associated one of the plurality of separate cells in the solar array to alternating current form provided on an output thereof. The system also includes a means for sensing a magnitude of the electrical output power or energy associated with each of the plurality of inverters. Each of the means for sensing produces an output signal proportional to the sensed magnitude of the electrical output power or energy provided by the associated inverter. Finally, the system includes a controller coupled to receive the output signals from each of the means for sensing and configured to generate the control signals for the drive mechanism that move the platform and solar array such that the electrical output signals from each of the separate cells in the solar array are optimized.

In a still further aspect, a method for tracking a solar array comprising at least three separate cells. Each of the separate cells provides an electrical output in direct current form. An associated inverter is coupled to receive the electrical output of each cell. The solar array is mounted on a platform coupled to a drive mechanism. The drive mechanism is configured to move the platform and solar array in response to received control signals. In a first step, a signal proportional to a magnitude of electrical power or energy provided by each associated inverter is generated for each separate cell. Next, each signal proportional to a magnitude of electrical power or energy provided by each associated inverter is provided to a controller. Thereafter, control signals are generated in a controller for the drive mechanism that move the platform and solar array such that the electrical output signals from each of the separate cells in the solar array are optimized. Finally, the platform and solar array are moved with the drive mechanism based on the control signals generated by the controller. In a further aspect, each inverter is a micro-inverter and the step of generating, for each separate cell, a signal proportional to a magnitude of electrical power or energy provided by each associated inverter is performed within the micro-inverter.

The features, functions, and advantages that have been discussed can be achieved independently in various embodiments or may be combined in yet other embodiments, further details of which can be seen with reference to the following description and drawings.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a solar array tracker control system according to the present disclosure; and

FIG. 2 is a flowchart of a method of operation of the solar array tracker control system according to the present disclosure.

### DETAILED DESCRIPTION

In the present disclosure, like reference numbers refer to like elements throughout the drawings, which illustrate various exemplary embodiments of the present disclosure.

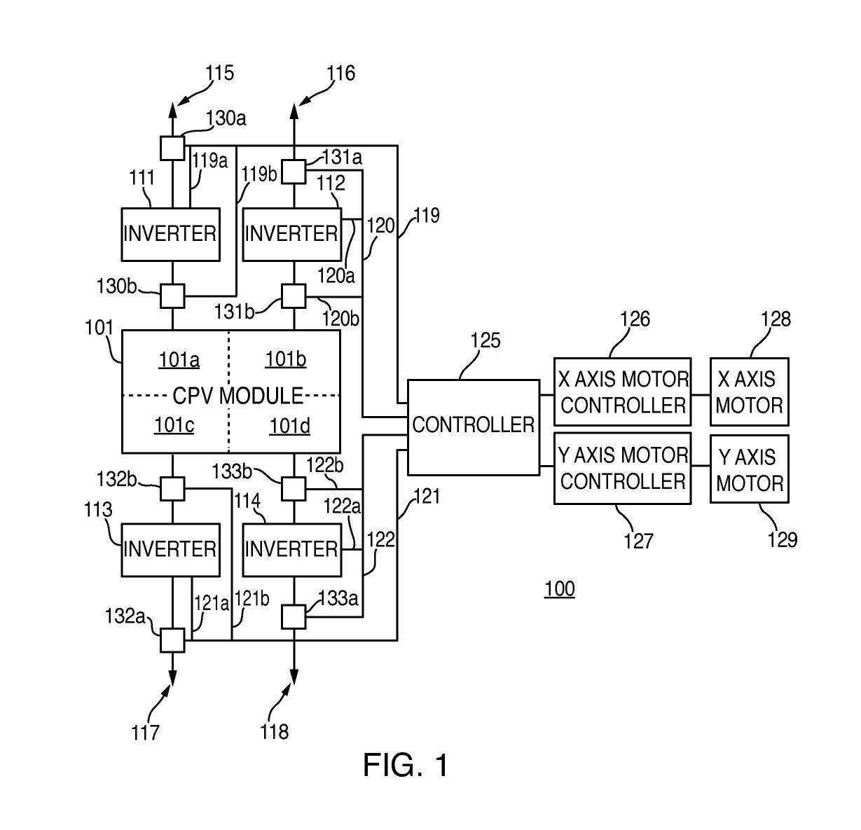

Referring now to FIG. 1, a dual-axis solar array tracker system 100 includes a solar array, e.g., a CPV cell array, module 101 including, for example, four segments 101a, 101b, 101c, 101d. Although the preferred embodiment of the present disclosure is described with respect to a CPV cell array module, in an alternative embodiment, an ordinary solar array module may be used instead. Solar array module 101 preferably includes four segments, but the system 100 may be used with a Solar array module having as few as three segments and a number greater than four as well, although four cells or a multiple of four cells is preferable. Each cell segment 101a, 101b, 101c, 101d is coupled to a respective inverter 111, 112, 113, 114 for generating a respective electrical output 115, 116, 117, 118, that, in turn, may be coupled to an electrical power grid in a conventional manner. Each inverter 111, 112, 113, 114 is preferably a solar micro-inverter. A micro-inverter converts the DC current produced by a solar cell to an AC current. Micro-inverters are available from a number of different companies, including, for example, Enphase® Energy. The outputs from a number of micro-inverters are typically combined and coupled to the power grid. The use of micro-inverters is known to improve efficiency over a single inverter coupled to convert the output from all cells of the array.

In a presently preferred embodiment, each inverter 111, 112, 113, 114 is a solar micro-inverter which includes an internal sensor for detecting the output power or energy of electrical output 115, 116, 117, 118 and provides an output signal to signal lines 119a, 120a, 121a, 122a which is proportional to the output power or energy provided by the associated micro-inverter, each signal line 119a, 120a, 121a, 121b coupled to a controller 125. Although separate signal lines are shown in FIG. 1, as one of ordinary skill in the art will readily recognize, other types of communications links (via appropriate interfaces) may be alternatively used to transfer the output signal from respective inverter 111, 112, 113, 114 to controller 125, including, but not limited to wireless signals and signals modulated on the AC output power lines 117, 118, 119, 120. In a first alternative embodiment, sensors 130a, 131a, 132a, 133a are coupled to monitor the output levels on the respective outputs 115, 116, 117, 118 of inverters 113, 114, 115, 116. Each sensor 130, 131, 132, 133 may be, for example, a Hall effect sensor used to detect the output AC current level on respective outputs 115, 116, 117, 118. The output signal from each sensor 130, 131, 132, 133 is coupled to controller 125 via respective signal lines 119, 120, 121, 122. In a second alternative embodiment, sensors 130b, 131b, 132b, 133b are coupled to monitor the input signals to respective inverters 113, 114, 115, 116 (instead of the output signal from each respective inverter). Signal lines 119b, 120b, 121b, 122b are used to couple the output signals from respective sensors 130b, 131b, 132b, 133b to controller 125 in this alternative embodiment.

The solar array module 101 is mounted on a platform driven by two motors, i.e., an x-axis motor 128 and a y-axis motor 129, to provide solar tracking of the sun. The mechanical drive system for solar array module 101 is conventional and may be, for example, the same as used in prior art tracking systems using separate sun sensors as discussed above.

Controller 125 is coupled to a drive mechanism comprising an x-axis motor controller 126, an associated x-axis motor 128, a y-axis motor controller 127 and an associated y-axis motor 129. Controller 125 is first coupled to the x-axis motor controller 126 and to y-axis controller 127. In turn, x-axis motor controller 126 is coupled to the x-axis motor 128 and y-axis motor controller 127 is coupled to y-axis motor 129. Controller 125 processes the signals from sensors 130, 131, 132, 133 to generate control signals for the x-axis motor controller 126 and for the y-axis motor controller 127. Controller 125 generates control signals in a similar manner to conventional systems which include separate sun sensors. In particular, controller 125 processes the signals from sensors 130, 131, 132, 133 as error signals to an open loop time of day signal to generate the respective x-axis motor controller and y-axis motor controller signals. However, since the signals provided to controller 125 are based directly on the output levels of each cell 101a, 101b, 101c, 101d, the tracking signals (and thus the movement of solar array module 101) are more accurate than the conventional systems using separate sun sensors. This enables system 100 to generate electricity more efficiently than conventional systems because, for example, nonlinear behavior of conventional quad cell-based sun sensors is eliminated. System 100 thus provides a more accurate and full aperture sample signal for each cell segment 101a, 101b, 101c, 101d and is simpler and thus less costly due to the use of the micro-inverters for both DC to AC conversion and as a source of the track error signals.

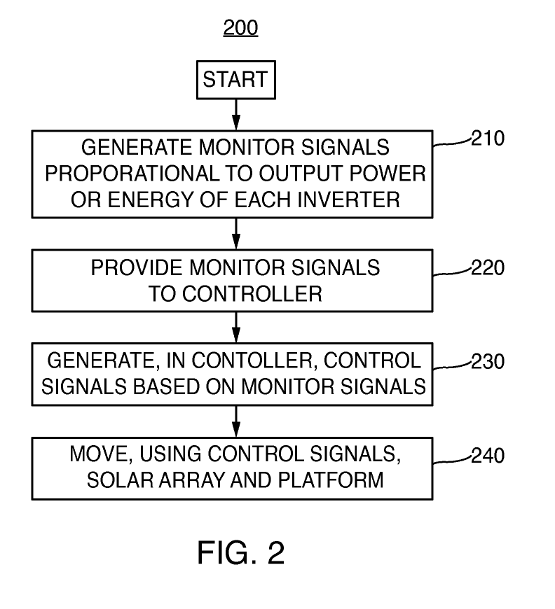

Referring now to FIG. 2, a flowchart 200 shows a method for tracking the solar array module 101 in FIG. 1. In particular, in a first step 210, a signal is generated for each separate cell which is proportional to a magnitude of electrical power or energy provided by each associated inverter. Next, at step 220, each signal proportional to a magnitude of electrical power or energy output by each associated inverter is provided to a controller. Then, at step 230, control signals are generated in the controller for the drive mechanism that moves the platform and solar array such that the electrical output signals from each of the separate cells in the solar array are optimized. Finally, at step 240, the platform and solar array are moved by the drive mechanism based on the control signals generated by the controller.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A solar array tracking system, comprising:
a solar array module having at least three separate cells, each of the separate cells providing an electrical output in direct current form, the solar array module mounted on a platform coupled to a drive mechanism, the drive mechanism configured to move the platform and solar array module in response to received control signals;
a plurality of inverters, one invertor for each of the plurality of separate cells in the solar array module, each of the plurality of inverters having an input coupled to receive the electrical output from a respective one of the plurality of separate cells in the solar array module, each of the inverters configured to convert the electrical output signal of the associated one of the plurality of separate cells in the solar array module to alternating current form provided on an output thereof;
a plurality of sensors, one sensor for each of the plurality of inverters, each sensor configured to provide an output signal proportional to a magnitude of the electrical power or energy provided by the associated inverter; and
a controller coupled to receive the output signals from each of the plurality of sensors and configured to generate the control signals for the drive mechanism that move the platform and solar array module such that the electrical output signals from each of the separate cells in the solar array module are optimized.

2. The solar array tracking system of claim 1, wherein each of the plurality of inverters is a micro-inverter.

3. The solar array tracking system of claim 1, wherein each of the plurality of sensors is within the associated inverter.

4. The solar array tracking system of claim 1, wherein each of the plurality of sensors is configured to sense the magnitude of the electrical power or energy provided by the associated inverter at an output of the associated inverter.

5. The solar array tracking system of claim 4, wherein each of the plurality of sensors is a Hall effect sensor.

6. The solar array tracking system of claim 1, wherein each of the plurality of sensors is configured to sense the magnitude of the electrical power or energy provided by the associated inverter at an input of the associated inverter.

7. The solar array tracking system of claim 6, wherein each of the plurality of sensors is a Hall effect sensor.

8. The solar array tracking system of claim 1, wherein the solar array module has four separate cells.

9. The solar array tracking system of claim 1, wherein the solar array module has a multiple of four separate cells.

10. A solar array tracking system, comprising:
a solar array module having at least three separate cells, each of the separate cells providing an electrical output in direct current form, the solar array module mounted on a platform coupled to a drive mechanism, the drive mechanism configured to move the platform and solar array module in response to received control signals;
a plurality of inverters, one invertor for each of the plurality of separate cells in the solar array module, each of the plurality of inverters having an input coupled to receive the electrical output from a respective one of the plurality of separate cells in the solar array module, each of the inverters configured to convert the electrical output signal of the associated one of the plurality of separate cells in the solar array module to alternating current form provided on an output thereof;
a means for sensing a magnitude of the electrical output power or energy associated with each of the plurality of inverters, each of the means for sensing producing an output signal proportional to the sensed magnitude of the electrical output power or energy provided by the associated inverter; and
a controller coupled to receive the output signals from each of the means for sensing and configured to generate the control signals for the drive mechanism that move the platform and solar array module such that the electrical output signals from each of the separate cells in the solar array module are optimized.

11. The solar array tracking system of claim 10, wherein each of the plurality of inverters is a micro-inverter.

12. The solar array tracking system of claim 10, wherein each of the plurality of sensors is within the associated inverter.

13. The solar array tracking system of claim 10, wherein each of the plurality of sensors is configured to sense the magnitude of the electrical power or energy provided by the associated inverter at an output of the associated inverter.

14. The solar array tracking system of claim 13, wherein each of the plurality of sensors is a Hall effect sensor.

15. The solar array tracking system of claim 10, wherein each of the plurality of sensors is configured to sense the magnitude of the electrical power or energy provided by the associated inverter at an input of the associated inverter.

16. The solar array tracking system of claim 15, wherein each of the plurality of sensors is a Hall effect sensor.

17. The solar array tracking system of claim 10, wherein the solar array module has four separate cells.

18. The solar array tracking system of claim 10, wherein the solar array module has a multiple of four separate cells.

19. A method for tracking a solar array module, the solar array module comprising at least three separate cells, each of the separate cells providing an electrical output in direct current form, an associated inverter coupled to receive the electrical output of each cell, the solar array module mounted on a platform coupled to a drive mechanism, the drive mechanism configured to move the platform and solar array module in response to received control signals, the method comprising the steps of:
generating, for each separate cell, a signal proportional to a magnitude of electrical power or energy provided by each associated inverter;
providing each signal proportional to a magnitude of electrical power or energy provided by each associated inverter to a controller;
generating, in the controller, control signals for the drive mechanism that move the platform and solar array module such that the electrical output signals from each of the separate cells in the solar array module are optimized; and
moving the platform and solar array module with the drive mechanism based on the control signals generated by the controller.

20. The method of claim 19, wherein each inverter is a micro-inverter and wherein the step of generating, for each separate cell, a signal proportional to a magnitude of electrical power or energy provided by each associated inverter is performed within the micro-inverter.
